(19) United States
(12) Patent Application Publication
(10) Pub. No.: US 2019/0195342 A1
(43) Pub. Date: Jun. 27, 2019

(54) TRANSMISSION SHIFTER ASSEMBLY WITH SECONDARY SHIFTING

(71) Applicant: Dura Operating, LLC, Auburn Hills, MI (US)

(72) Inventor: Dale A. Beattie, Norton Shores, MI (US)

(21) Appl. No.: 15/850,844

(22) Filed: Dec. 21, 2017

(51) Int. Cl. F16H 59/10; F16H 59/02; G05G 5/04; B60K 20/02

(52) U.S. Cl. CPC F16H 59/10; F16H 59/0278; G05G 5/04; F16H 2063/423; F16H 2059/0282; F16H 2059/0295; B60K 20/02

(57) ABSTRACT

At least some implementations of a transmission gear shifter include a first shift member having a body rotatable about an axis among multiple positions, a retainer movable relative to the body, an actuator coupled to the retainer and a second shift member coupled to the first shift member. The retainer is movable between a first position in which the retainer prevents movement of the body and a second position in which the retainer permits movement of the body. The actuator drives the retainer between the first position and second position. And the second shift member is driven by the actuator between first and second positions to rotate the body. In at least some implementations, the second shift member is engaged by the retainer and driven by movement of the retainer.

### TECHNICAL FIELD

The present disclosure relates generally to a gear shift system for a vehicle transmission.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift lever movement to a transmission shift mechanism. Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator. It may be desirable, in at least some circumstances, to selectively prevent movement of the shift lever to prevent shifting the transmission at least until certain conditions are satisfied. For example, to shift the transmission out of park, a vehicle brake may need to be depressed or some other driver action may be needed. In some instances, it may be desirable to shift the transmission without a user command to do so.

### SUMMARY

At least some implementations of a transmission gear shifter include a first shift member having a body rotatable about an axis among multiple positions, a retainer movable relative to the body, an actuator coupled to the retainer and a second shift member coupled to the first shift member. The retainer is movable between a first position in which the retainer prevents movement of the body and a second position in which the retainer permits movement of the body. The actuator drives the retainer between the first position and second position. And the second shift member is driven by the actuator between first and second positions to rotate the body. In at least some implementations, the second shift member is engaged by the retainer and driven by movement of the retainer.

In at least some implementations, the retainer and body include control features that are radially overlapped relative to the axis when the retainer is in the first position are not radially overlapped when the retainer is in the second position. The control features may include include axially extending stop surfaces of the retainer and the body. The retainer may include one or more control features with one of the one or more retainer control features selectively and releasably engageable with a first control feature of the body when the body is in a first position, and the body may also include a second control feature that is selectively and releasably engageable by one of the one or more retainer control features when the body is in a second position that is different than the first position of the body.

In at least some implementations, the second shift member has a first end, a second end and is coupled to a pivot between the first end and second end for rotation of the second shift member about the pivot, and the second shift member may be coupled to the body between the pivot and first end and the retainer is engageable with the second shift member between the pivot and second end, and wherein rotation of the body causes the second shift member to rotate about the pivot and engagement of the retainer with the second shift member during movement of the retainer causes the second shift member to rotate about the pivot and rotate the body. The distance from the pivot to the first end may be greater than the distance from the pivot to the second end, and the body may rotate about an axis that is parallel to an axis of the pivot. Further, the second shift member may rotate about the axis of the pivot and in at least one position of the body, the second shift member may intersect an imaginary line that intersects the axis about which the body rotates and the axis of the pivot.

In at least some implementations, the second shift member includes a slot and the body includes a drive member received within the slot, and during rotation of the body, the drive member moves relative to the second shift member within the slot. The drive member may be closely received within the slot to prevent lost motion between the body and the second shift member. In at least some implementations, the retainer includes a cam surface at least a portion of which is located between the pivot and second end, and the cam surface is inclined relative to the path of movement of the retainer so that engagement of the retainer with the cam surface of the second shift member causes increased rotation of the body.

In at least some implementations, a shifter for a vehicle transmission includes a first shift member having a body rotatable about an axis between a park position, a reverse position, a neutral position and a drive position, and the first shift member has at least one shifter control feature. A retainer is movable along a linear path relative to the body and has at least one retainer control feature, the retainer is movable between a first position in which the retainer control feature overlaps the shifter control feature when the shifter is in the park position to prevent rotation of the body, and a second position in which the retainer control feature does not overlap the shifter control feature and rotation of the body is permitted. An actuator is coupled to the retainer to drive the retainer between the first position and second position. And a second shift member is coupled to the first shift member so that the second shift member is in a first position when the first shift member is in the park position and the second shift member is in a position different than the first position when the first shift member is not in the park position, and the second shift member has a portion engageable by the retainer as the retainer moves from the second position to the first position so that when the retainer is in the first position the second shift member is in the first position and the first shift member is in the park position.

### BRIEF DESCRIPTION OF THE DRAWINGS

The following detailed description of some implementations of a shifter will be set forth with regard to the accompanying drawings, in which:

FIG. 1 is a perspective view of a shifter with a portion of a first shift member, shown as a rotatable selector, in section and only part of an outer housing shown;

FIG. 2 is a side view of the shifter of FIG. 1;

FIG. 3 is a perspective view of certain components of the shifter;

FIG. 4 is a perspective view of the components shown in FIG. 3 from a different angle;

FIG. 5 is a perspective view of a second body of the selector, a second shift member, a retainer, an actuator for the retainer and a portion of a lower housing or base;

FIG. 6 is a perspective view similar to FIG. 5 but without the second body of the selector;

FIG. 7 is a perspective view of the components shown in FIGS. 3 and 4, illustrating the selector in a first position and the retainer in a first position blocking rotation of the selector out of its first position;

FIG. 8 is a bottom view showing the actuator, the retainer in section, the second shift member and the second body, all in the positions shown in FIG. 7;

FIG. 9 is a view similar to FIG. 7 but with the retainer in a second position;

FIG. 10 is a view similar to FIG. 8 but with the retainer in the second position;

FIG. 11 is a view similar to FIG. 10 but with the second body in a second position;

FIG. 12 is a view similar to FIG. 11 but with the second body in a third position;

FIG. 13 is a view similar to FIG. 9 but with the second body in the third position and the retainer in a third position blocking rotation of the second body out of the third position;

FIG. 14 is a view similar to FIG. 12 but with the second body and retainer in the positions shown in FIG. 13;

FIG. 15 is a view similar to FIG. 14 but with the second body in a fourth position and the retainer in its second position permitting rotation of the second body relative to the retainer; and

FIG. 16 is a top view of the components in the positions shown in FIG. 15.

### DETAILED DESCRIPTION

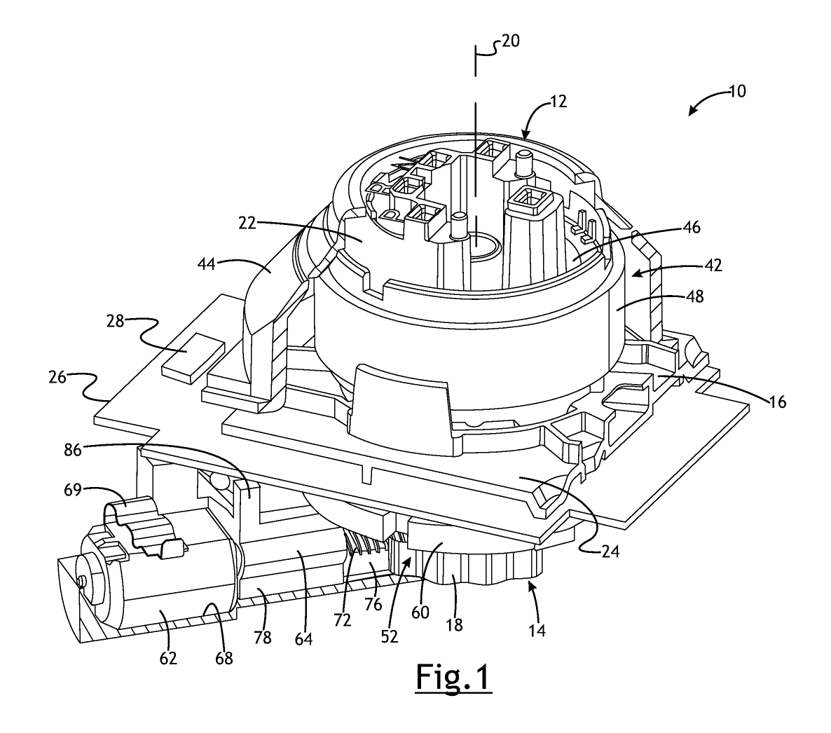

Referring in more detail to the drawings, FIGS. 1-5 illustrate a rotary gear shifter 10 that may be used to shift among various gears of a transmission. In at least some implementations, the shifter 10 is not directly mechanically coupled to the transmission and instead communicates electrically with an actuator coupled to the transmission that, in turn, causes a change in the selected transmission gear in a so-called shift-by-wire system. The shifter 10 may include a first shift member, such as a dial, knob or other rotary selector 12, that may be manually rotated by a user through multiple positions corresponding to multiple gears of the vehicle transmission. By way of non-limiting examples, the selector 12 may include and be rotated to one or more positions that correspond to park, reverse, neutral and drive gears for a vehicle transmission.

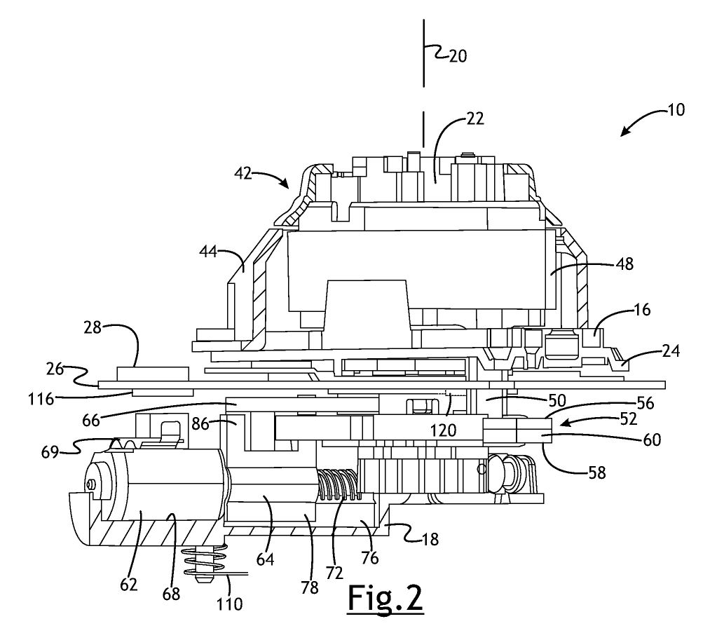

The selector 12 may be mounted to a housing 14 (only part of which is shown to better illustrate internal components) that is arranged to be mounted within a vehicle. The housing 14 may have an upper portion or cover 16 (FIGS. 1 and 2) and a base 18 coupled to the cover to define an at least partial enclosure for the selector 12 and related shifter components, as set forth below. The selector 12 may be carried by the housing 14 for rotation relative to the housing about a central axis 20. And so that the selector may be manually actuated by a user to cause a transmission gear change, the selector 12 may extend at least partially out of the cover 16. In the example shown, the cover 16 includes a generally cylindrical column 22 about which the selector 12 rotates and a flange 24 from which the column 22 extends and which is coupled to the base 18.

Within the enclosure, the shifter 10 may include a circuit board 26 on which one or more circuit elements, such as a microprocessor or controller 28, may be mounted. In at least some implementations, the circuit board 26 is generally planar and is mounted perpendicularly to the axis 20 of rotation of the selector 12. If desired, a gasket or other seals may be provided between the cover 16 and the circuit board 26. For example, a gasket may be provided between the flange 24 of the cover 16 and the circuit board 26. The gasket and/or other seals may help to isolate the circuit elements on the circuit board 26 from liquids and other contaminants, if desired.

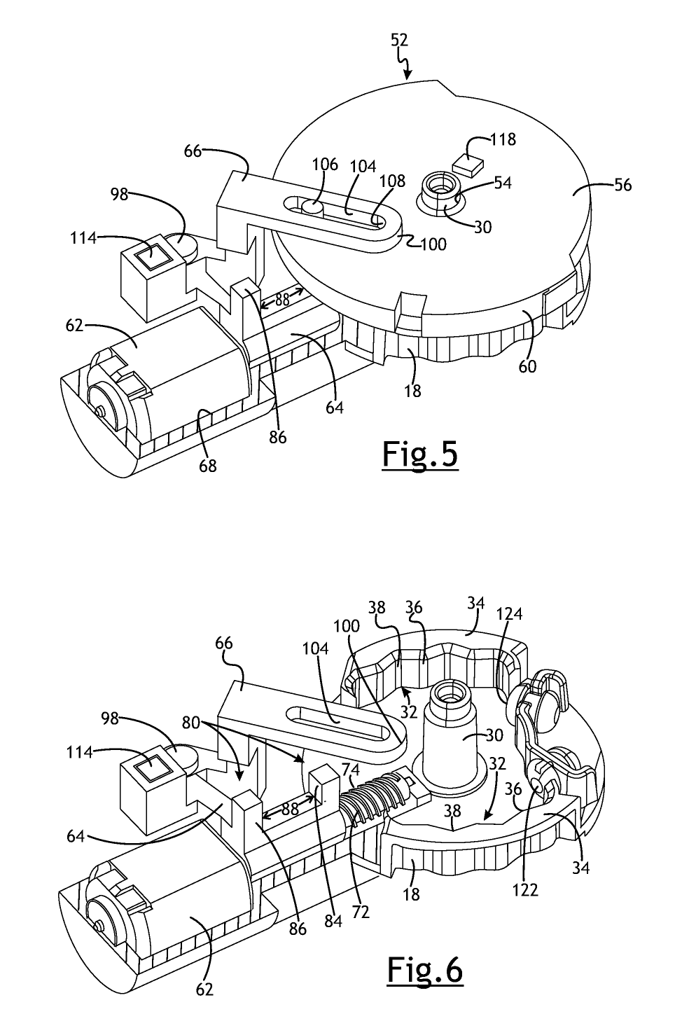

The housing base 18, or at least a portion thereof, is shown in FIGS. 1-7 among others. The base 18 may include a post 30 (FIGS. 5 and 6) about which part of the selector 12 is received and which may help guide the rotation of the selector 12, and other features to mount or interact with various components within the housing 14, as will be discussed below. In at least some implementations, the base 18 may include one or more feedback surfaces 32 (FIG. 6) defined in one or more segments 34 that span a desired circumferential distance that may be sufficient to include the range of rotary motion of the selector 12. Radially inner surfaces 32 of the segments 34 face inwardly toward the axis 20 and have circumferentially spaced apart peaks 36 and valleys 38 at different radial distances.

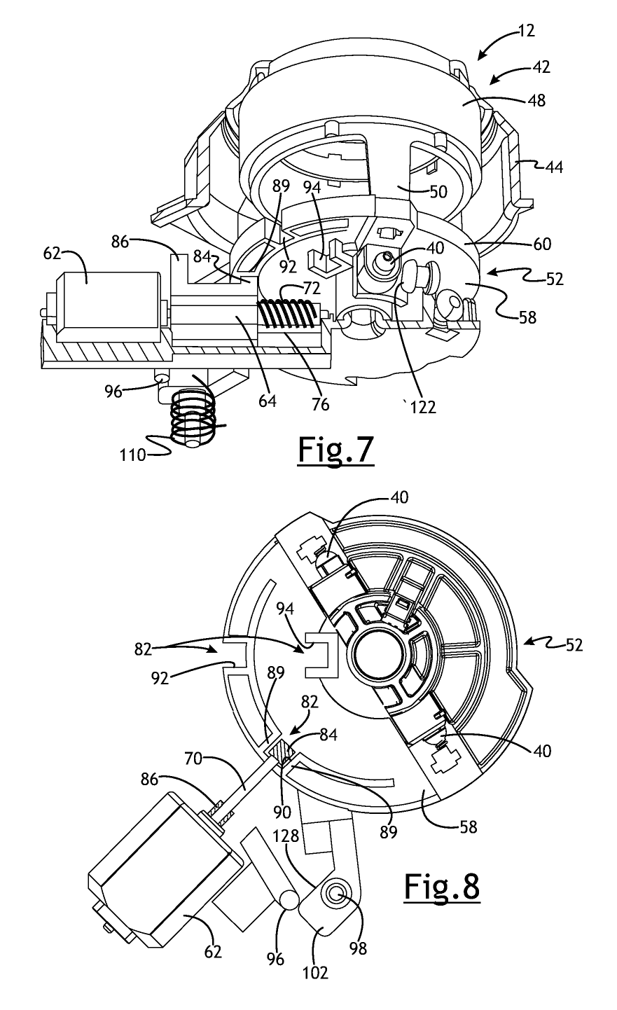

Spring-biased or flexible plungers 40 (FIGS. 7-15) coupled to the selector 12 ride along the feedback surfaces 32 as the selector 12 is rotated to provide force feedback to a person rotating the selector. More specifically, the valleys may correspond to the various positions of the selector (P, R, N and D) and an increased force may be needed to pass the plungers 40 over a peak 36 between adjacent valleys 38, and then the spring or other return force may tend to assist selector rotation toward a valley as the plunger 40 rides along an inclined portion of a feedback surface 32 between a peak and valley. The variation in force needed to rotate the selector 12 that is created by these force feedback surfaces 32 assist the user in finding a desired position, and also in retaining the selector 12 in a selected position as an increased force is needed to remove the plunger 40 from a valley 38 (doing so requires compression of the spring). While described with regard to a spring biasing a plunger 40, the plunger 40 could instead be made from a flexible and resilient material that is compressed as the plunger nears and passes by a peak 36 and expands as the plunger nears and enters a valley 38.

In the example shown, the base 18 includes two diametrically opposed segments 34 and the selector 12 includes two diametrically opposed plungers 40 to provided balanced forces on the selector. Of course, this is just one example and other arrangements may be used including, for example, axially facing feedback surfaces instead of the radially oriented surfaces shown, one plunger and one segment, or more than two sets of plungers and feedback surfaces.

The selector 12 may include a user actuated first body 42 that may include or be coupled to a decorative cover 44 that is fixed to the first body for co-rotation with the first body. The first body 42 may include a cavity 46 or open space in which one or more buttons, lights, wires or other devices and things may be mounted on or adjacent to the column. The buttons may permit some shifting of the transmission (e.g. manual upshifts and downshifts in a sport mode), selection of infotainment system functions (e.g. radio, navigation and the like), and/or selection of other vehicle functions (e.g. heating and cooling settings). The light or lights may provide illumination of certain features of the selector 12, such as various indicia or features used to indicate the various positions of the selector. In the illustrated example, the letters P, R, N and D are provided on the selector cover 44 and may be illuminated when selected.

The cavity 46 of the first body 42 may be defined at least in part by a cylindrical sidewall 48 which may be open at its ends, if desired. The first body 42 may also include one or more legs 50 (see e.g. FIGS. 2-4) that extend axially from the sidewall 48 and are coupled to a second body 52 for co-rotation of the first body 42 and second body 52. This provides some space between the first and second bodies 42, 52 in which components may be received. Of course, the legs 50 and provided space between the first and second bodies 42, 52 are not necessary and any such components can be provided within the cavity 46 or not at all, as desired.

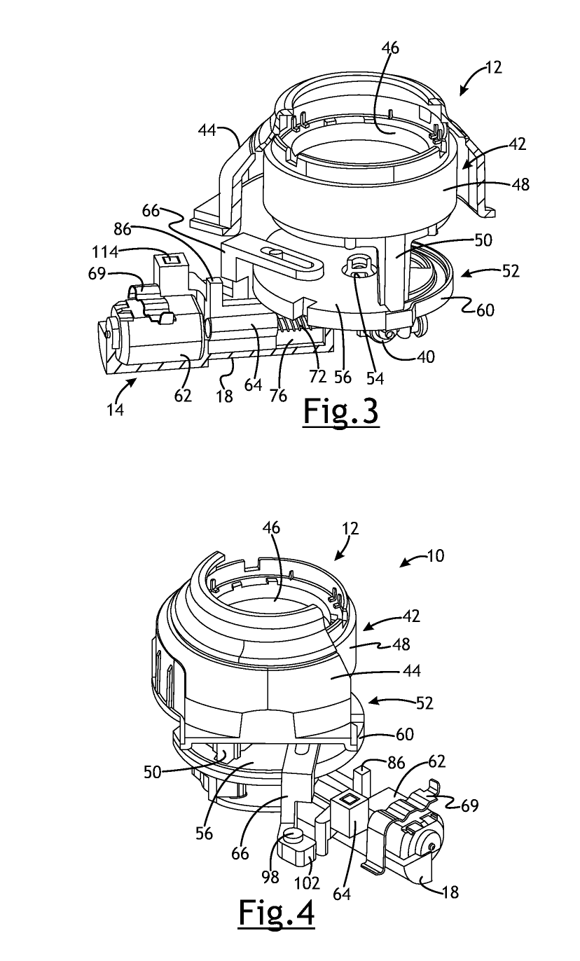

The second body 52 may be fixed to the legs 50 or some other portion of the first body 42 for co-rotation with the first body. The second body 52 may be mounted to the housing 14, such as by the post 30 that extends into or through a central opening 54 (FIGS. 3 and 5) in the second body 52 so that the second body (and connected first body) rotate relative to the post and housing. In the example shown, the second body 52 is disc-shaped, with an upper face 56 facing the first body 42, a lower face 58 that faces in the opposite direction (e.g. toward the base 18 of the housing 14) and an axially and circumferentially extending sidewall 60 at the radial outer surface of the second body 52.

Further, the circuit board 26 may extend between the first and second bodies 42, 52 of the selector 12, with the legs 50 extending through holes in the circuit board, or located outboard (e.g. adjacent to side edges) of the circuit board. A portion of the upper housing 16, such as the flange 24 and column 22, may also extend between the first and second bodies 42, 52 of the selector 12 to facilitate rotary mounting of the selector. In addition to or instead of these things, the electronic controller 28, which may include a microprocessor, could be received within the cavity 46. The controller 28 may be used to manage the operation of the shifter 10 including any buttons, lights or other features provided with the shifter, if desired. With portions of the selector 12 on either side of the circuit board 26, various electronic components may be located in close proximity to different portions of the selector to facilitate electrical coupling of the components to the circuit board 26 and controller 28.

An actuator 62 may be provided to drive one or both of a retainer 64 and a second shift member 66. As set forth in more detail below, the retainer 64 may selectively block rotation of the selector 12 and the second shift member 66 may be driven in certain circumstances to rotate the selector 12 and cause a transmission gear change without user actuation of the selector. In the example shown, the actuator 62 is carried by the housing base 18, which may include a cavity 68 in which a portion of the actuator is received. A clip 69 may overlie the actuator to secure the actuator 62 to the base 18, if desired.

In at least some implementations, the actuator 62 may be any desired form of rotary or linear actuator suitable to move the retainer 64 relative to the second body 52 as set forth below. In the example shown, the actuator is a reversible electric motor 62 with a rotary drive shaft 70. The drive shaft 70 is coupled to a drive member 72 that is coupled to and drives the retainer 64. In the example shown, the drive member is a cylindrical spindle 72 that has one or more outwardly extending threads 74 (FIG. 6) that mate with internal thread(s) of the retainer 64 to linearly drive the retainer relative to the actuator 62 and the second body 52. When the drive shaft 70 and spindle 72 are rotated in a first direction the retainer 64 is moved away from the motor 62, and when the drive shaft 70 and spindle 72 are rotated in a second direction the retainer 64 is moved toward the motor 62. The motor 62 may be controlled and actuated by the controller 28 on the circuit board 26 or by a different vehicle controller, as desired.

As shown in FIGS. 1 and 2, in at least some implementations, the housing 14 may include or carry a guide member or track 76 that extends at least part of the way between the actuator cavity 68 and the portion of the housing 14 including the post 30. The retainer 64 may be slidably moved along a linear path defined by the track 76 and relative to the second body 52. The track 76 may be defined by one or more linear surfaces of the base 18, or by a component carried by the base. Accordingly, the rotary motion of the spindle 72 causes linear movement of the retainer 64, and rotation of the retainer is prevented by engagement of the retainer with the track 76. In this regard, the retainer 64 may include one or more depending flanges 78 arranged parallel to the track 76 and axially overlapped with the track (relative to the main axis 20) to guide movement of the retainer 64 along the track 76.

To control rotation of the second body 52 and hence, the selector 12, the retainer 64 may include one or more control features 80 (FIG. 6) that interact with control features 82 (FIG. 8) provided on the selector (e.g. the second body 52). The retainer control features 80 and selector control features 82 cooperate to inhibit or prevent rotation of the selector 12 in certain positions or the selector and/or in certain operating circumstances. For example, the retainer 64 may be positioned so that one or more of its control features 80 overlap one or more selector control surfaces 82 to prevent rotation of the second body 52 when the selector 12 is in the position corresponding to the transmission being in park. To shift the transmission out of park, a driver may have to take some action before rotating the selector 12, such as applying a vehicle brake. Upon detection that the vehicle brake has been applied, the actuator 62 may be energized to drive the retainer 64 to a position in which the retainer control features 80 are not overlapped with the selector control features 82 so that the second body 52 may be rotated relative to the retainer 64.

Similarly, in some instances, such as when a vehicle transmission has been in the neutral gear position for longer than a threshold time, it may be desirable to prevent shifting out of neutral without the driver taking some prerequisite action prior to rotating the selector 12. This is a so-called neutral lock. Such driver action may be applying the brake or pushing a button, for example. Upon detection that the transmission has been in neutral for longer than the threshold time, the actuator 62 may be commanded to move the retainer 64 to a position in which one or more of its control features 80 prevent rotation of the second body 52. And upon detection of the prerequisite driver action to shift out of neutral, the actuator 62 may drive the retainer 64 to a position that permits the second body 52 to be rotated relative to the retainer 64 so that the selector 12 may be rotated to shift the transmission.

In at least some implementations, the retainer control features 80 and selector control features 82 include opposing surfaces that, when aligned, are axially and radially overlapped so that rotation of the selector 12 is prevented. The control features 80, 82 may include some combination of blocking members and voids, wherein a blocking member may be received at least partially in a void or space defined by control features when it is desired to prevent rotation of the selector. In the example shown, the retainer includes the blocking members and the second body includes the voids, as is described further below. But other arrangements may be used including providing the second member with one or more blocking members and the retainer with one or more voids, or some combination of these.

In the example shown, the retainer 64 has a first control feature or first blocking member shown as a first tab 84 that has oppositely facing surfaces that extend axially and radially (relative to the axis 20 of the second body 52). In the example shown, the retainer 64 also has a second control feature or second blocking member shown as a second tab 86 that also has oppositely facing surfaces that extend axially and radially. The second tab 86 is radially spaced from the first tab 84 and provides a second structure that may be used to selectively prevent rotation of the second body 52. In the example shown, the first tab 84 is located radially inwardly of the second tab 86 (that is, the first tab is closer to the axis 20 than is the second tab). The first tab may be arranged radially within the periphery of the second body 52 in at least some positions of the retainer 64, and the second tab 86 may be radially outboard of the second body 52 in at least some positions of the retainer 64. A gap 88 (FIGS. 5 and 6) may be provided between the tabs 84, 86 and the sidewall 60 of the second body 52 may be received in the gap 88 in some positions of the retainer 64. Of course, other arrangements may be used, as desired, including only one tab or more than two tabs, as well as tabs in different locations and structures other than tabs. The tabs 84, 86 may be provided in the same piece of material as the portion of the retainer 64 engaged with the spindle 72 and the retainer may thus be defined in a single, unitary body, if desired.

As shown in FIGS. 7-15, in more detail, the second body 52 has a first control feature that includes at least one stop surface 89 (FIGS. 8 and 10) that defines at least part of a first void 90 arranged to receive a tab 84, 86 of the retainer 64 so that the tab and stop surface are radially overlapped. Two stop surfaces 89 that define the first void 90 are shown as extending from the lower face 58 of the second body 52 and having a radial length and axial height. When the first tab 84 is radially aligned with the first void 90, rotation of the second body 52 is prevented by engagement of the stop surfaces 89 with the retainer (e.g. a tab).

In at least some implementations, the second body 52 may include a second control feature that includes opposed stop surfaces 91 (FIG. 10) circumferentially spaced apart to define a second void 92 between them. The second void 92 is shown as being open to the radial periphery of the second body 52 and has a radial length and axial height. The second tab 86 of the retainer 64 may be selectively received within the second void 92 such that rotation of the second body 52 is prevented by engagement of the second body 52 with the retainer (e.g. the second tab 86).

In at least some implementations, the second body 52 may include a third control feature. The third control feature may also include opposed stop surfaces 93 (FIG. 10) circumferentially spaced apart to define a third void 94 between them. Like the first void 90, the stop surfaces 93 of the third void 94 are shown as extending from the lower face 58 of the second body 52 and have a radial length and axial height. When the first tab 84 is received in the third void 94, rotation of the second body 52 is prevented. In at least some implementations, the third void 94 is radially aligned with the second void 92 and the first and second tabs 84, 86 are received in the second and third voids 92, 94 at the same time. Of course, other arrangements may be provided and only one tab and one void may be needed to prevent selector rotation in any position.

Any desired number and arrangement of control features may be provided on the retainer 64 and second body 52 to provide desired control of the selector rotation. The control features could also be provided on the first body and the retainer 64 could interact with the first body as desired, or with another component that moves as the selector 12 is rotated.

The retainer 64 may further include a drive surface 96 arranged to engage, during at least a portion of the movement of the retainer, the second shift member 66 that is coupled to the selector 12. When the drive surface 96 of the retainer 64 engages and displaces the second shift member 66, the second shift member causes rotation of the selector 12 and a corresponding transmission gear shift. This may be desirable in a number of situations. For example, if a vehicle is turned off without first rotating the selector to shift the transmission to park, it may be desirable to automatically shift the vehicle into park via the second shift member 66. The second shift member 66 could also or instead rotate the selector 12 to shift the transmission to neutral or some other position, as desired.

With reference to FIG. 16, in at least some implementations, the second shift member 66 is a rigid arm that is coupled to a pivot 98 between first and second ends 100, 102 for rotation about the pivot 98, the axis of which may be parallel to the rotational axis 20 of the selector 12. The second shift member 66 is coupled to the second body 52 between the pivot 98 and first end 100 and the retainer 64 is engageable with the second shift member 66 between the pivot 98 and second end 102. Rotation of the second body 52 causes the second shift member 66 to rotate about the pivot 98, and engagement of the retainer 64 with the second shift member 66 during movement of the retainer 64 causes the second shift member 66 to rotate about the pivot 98 which rotates the second body 52, and hence, the entire selector 12.

In the implementations shown, the second shift member 66 includes a slot 104 that extends between the pivot 98 and first end 100, and the second body 52 includes a drive member, shown as a post 106 received within the slot 104. During rotation of the second body 52, the post 106 moves relative to the second shift member 66 within the slot 64. The distance from the pivot 98 to an end 108 of the slot 104 closest to the first end 100 of the second shift member may be greater than the distance from the second end 102 to the pivot 98 to provide a mechanical advantage so that comparatively less movement of the retainer 64 (when engaged with the second shift member 66) causes more rotation of the second body 52. Further, the post 106 may be located toward the radial periphery of the second body 52 to improve the leverage and force for rotation of the selector 12 by the second shift member 66. In at least some implementations, the actuator 62, through the retainer 64 and second shift member 66, may move the selector 12 from any position back to the position corresponding to park. In other words, the second shift member 66 and retainer 64 are arranged to move the selector 12 through its full rotary range of motion. The post 106 may be somewhat closely received within the slot 104 to reduce or eliminate lost motion between the post 106 and second shift member 66. That is, when the post 106 moves (due to rotation of the second body 52) the second shift member 66 moves, and vice versa. To maintain the second shift member 66 in contact with the post 106, a torsion spring 110 (FIG. 7) may rotatably bias the second shift member 66 about the pivot 98. Further, the post 106 and second shift member 66 may move from one side of an imaginary line 112 (FIG. 16) or plane extending between the pivot 98 and axis 20 to the other side during the range of rotation of the selector 12. The post 106 is closest to the pivot 98 when aligned with the line 112 between the pivot 98 and axis 20.

The shifter 10 may include one or more position sensors to provide a positive indication of the position of one or more components, such as the retainer 64 and the selector 12. As shown in FIG. 5 (among others), a first sensor element may be coupled to the retainer 64 and is shown as including a magnet 114 (FIGS. 3, 5 and 6) received within a cavity of the retainer 64. A first sensor 116 (FIG. 2) may be carried by the circuit board 26, for example, and may be a hall-effect or other type of sensor responsive to movement of the magnet 114 as the retainer 64 moves. Of course, sensor types other than magnetic may be used, as desired, including but not limited to optical and contact based resistive sensors (e.g. potentiometers). A second sensor element may be carried by the selector 12 for rotation about the axis 20 when the selector rotates, to facilitate a determination of the rotary position of the selector. In the example shown, the second sensor element includes a magnet 118 (FIG. 5) that is fixed to the second body 52. A second sensor 120 (FIG. 2) may be carried by the circuit board 26, for example, and may be a hall-effect or other type of sensor responsive to movement of the second magnet as the second body rotates. Of course, sensor types other than magnetic field sensors may be used, as desired, including but not limited to optical and contact based resistive sensors (e.g. potentiometers). The first and second sensors 116, 120 may be coupled to the controller 28 so that the positions of the retainer 64 and second body/selector 12 can be determined during operation of the shifter 10.

The operation of the shifter 10 will now be described. In FIGS. 7 and 8, the shifter is shown in a park lock position. In this position, the selector 12 is in a first position that corresponds to the transmission being in park, and the retainer 64 is in a first position in which the retainer prevents rotation of the selector 12. In more detail, in the position shown, the first tab 84 of the retainer 64 is received in the first void 90 of the second body 52. So arranged, rotation of the selector 12 is prevented by engagement of the second body 52 with the first tab 84. While the first void 90 is shown as including opposed stop surfaces 89, rotation of the selector 12 in one direction may be blocked by engagement of the selector with a separate stop surface, for example, a stop surface defined by the housing or another component. In the example shown, the stop surface is provided by a cushion 122 (FIGS. 6 and 7) that is mounted to the housing 14 to provide a less abrupt stop of the selector rotation. A similar cushion 124 (FIG. 6) and stop surface may be provided at the opposite end of the rotation of the selector 12 and rotation of the selector 12 may be confined to occur between the opposed stop surfaces 122, 124. Accordingly, the selector 12 may only be rotated in one direction out of the park position, and the first void 92 may be arranged to prevent rotation of the selector in that direction without need for a second stop surface 89.

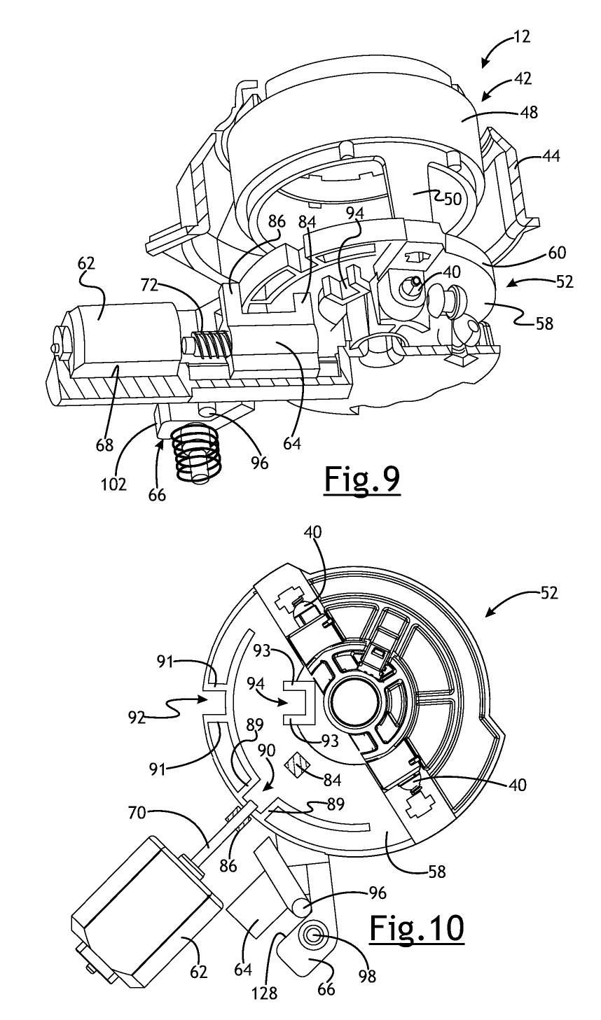

To permit rotation of the selector 12 out of the park position, the actuator 62 is commanded to move the retainer 64 away from the first position, to a second position in which the retainer does not prevent rotation of the selector. That is, the first tab 84 is moved out of and is radially spaced from the first void 90, as is shown in FIGS. 9 and 10. In the views of FIGS. 8, 10-12, 14 and 15, to facilitate view of the tabs 84, 86, only a portion of the retainer 64 is shown and the tabs appear to be floating. Movement of the retainer 64 to the second position may occur in response to the driver taking some prerequisite action, such as actuating a vehicle brake or otherwise. In this position, the selector 12 may be rotated out of the park gear without the retainer 64 interfering or blocking rotation of the second body 52.

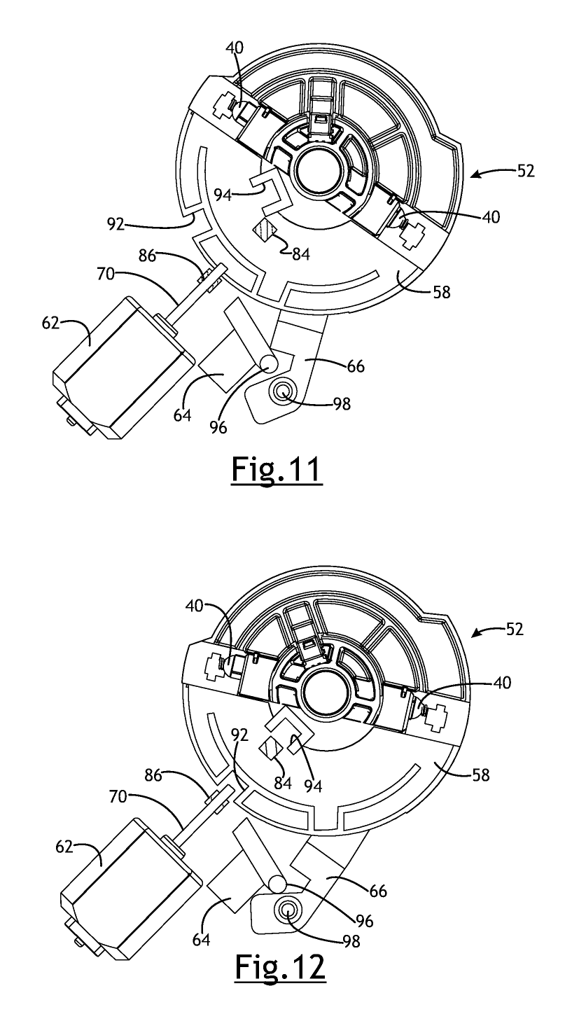

FIG. 11 illustrates the selector 12 in a second position, which corresponds to the transmission being in reverse gear. The retainer 64 is in its second position and neither tab 84, 86 of the retainer is overlapped with a void 90, 92, 94 of the second body 52. Thus, the selector 12 may be rotated from the second position to a third position (corresponding to the transmission being in neutral) or back to the first position (corresponding to park).

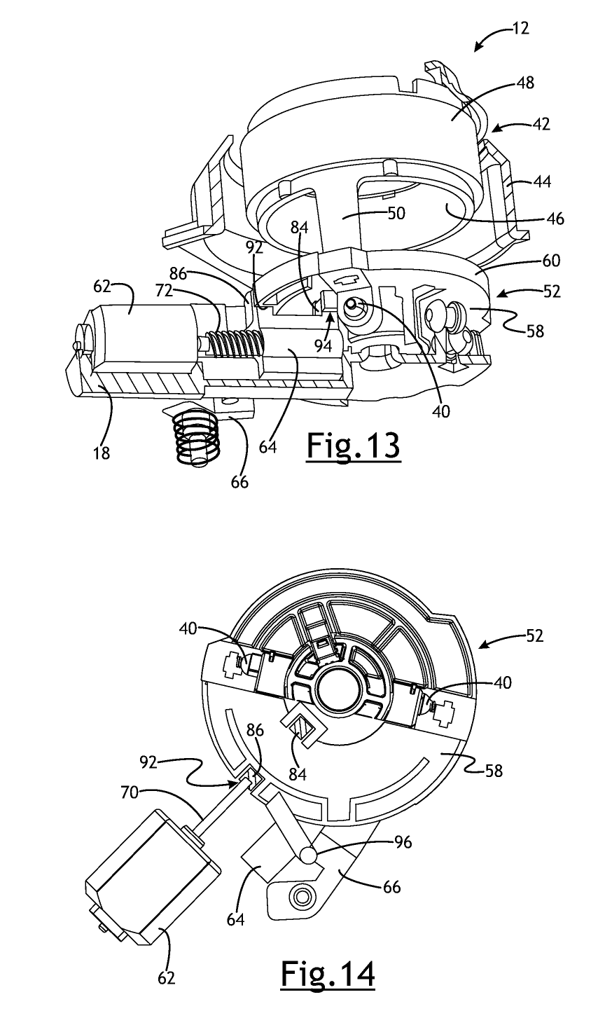

FIG. 12 illustrates the selector 12 in the third position and the retainer 64 in the second position. In this arrangement, the vehicle transmission is in neutral and the selector 12 may be rotated from the third position back to the second position or into a fourth position (corresponding to the transmission being in a forward drive gear). If one or more criteria are met, the controller 28 will cause the actuator 62 to move the retainer 64 relative to the second body 52 so that the retainer 64 blocks rotation of the selector 12 out of the third position. In FIGS. 13 and 14, the retainer 64 is shown in a third position. In this position, the second tab 86 is received within the second void 92, and the first tab 84 is received in the third void 94. While both tabs 84, 86 are shown as blocking rotation of the second body 52, only one may be needed. Further, this third position of the retainer puts the retainer 64 closest to the axis 20 and farthest from the actuator 62, although other arrangements may be used. In this position of the shifter 10, the selector 12 cannot be rotated to cause a transmission shift without the retainer 64 being moved to unblock rotation of the second body 52.

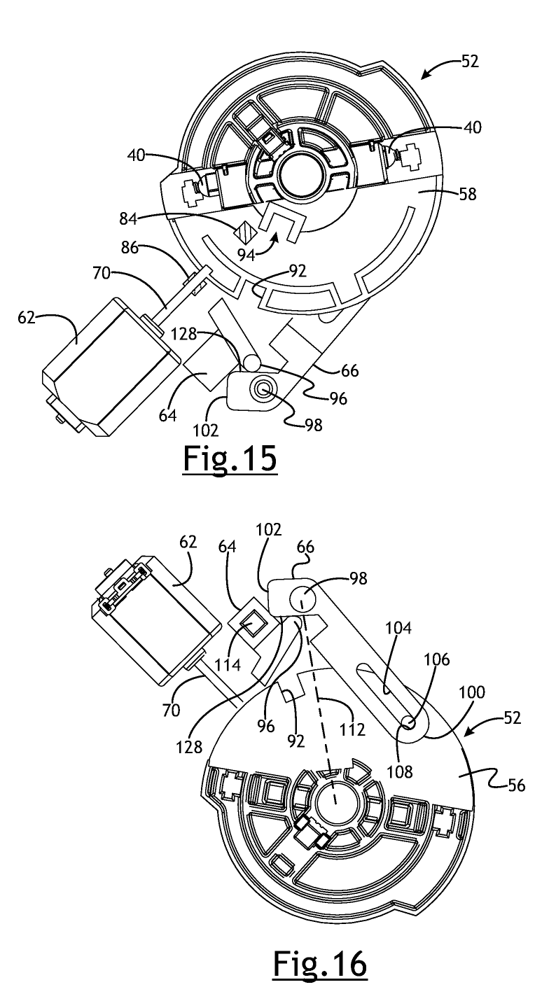

When the controller 28 actuates the actuator 62, the retainer 64 is moved from the third position to or toward the second position sufficiently such that the tabs 84, 86 are clear of the voids 92, 94. After this retainer movement, the selector 12 can be rotated to the fourth position, as shown in FIGS. 15 and 16, or to the second position, as shown in FIG. 11.

As noted above, rotation of the selector 12 moves the second shift member 66 as can be seen by comparison in the various figures, especially FIG. 5 which shows a first position of the second shift member 66 which is achieved when the selector 12 is in the first position and FIG. 16 which shows a second position of the second shift member 66 which is achieved when the selector 12 is in the fourth position (or some position other than the first position of the selector).

In at least some implementations, when the selector 12 is in a position other than the first position, the selector 12 may be driven to the first position or back toward the first position by the actuator 62 acting on the second shift member 66 through the retainer 64. In this position shown in FIGS. 15 and 16, the drive surface 96 of the retainer 64 is engaged with a cam surface 128 of the second shift member 66 near the pivot 98. The cam surface 128 is, at least when the selector 12 is not in the first position, not parallel to the path of movement of the retainer drive surface 96. Driving the retainer 64 back toward the actuator 62 causes the drive surface 96 to engage the cam surface 128 and rotate the second shift member 66 about the pivot 98. Rotation of the second shift member 66 drives the second body 52 for rotation by engagement of the second shift member 66 with the post 106.

In at least some implementations, the cam surface 128 is at its greatest angle relative to the path of motion of the drive surface 96 when the selector 12 is in the fourth or drive position, or whatever is the furthest position of the selector from the first or park position. The angle of the cam surface 128 relative to the path of motion of the retainer 64 and its drive surface 96 decreases as the second shift member 66 rotates in the direction that corresponds with the selector rotation back toward the first or park position. As the selector 12 rotates, the plungers 40 ride over the force feedback features 32, so the actuator 62, retainer 64 and second shift member 66 need to provide sufficient force to rotate the selector 12 through the various positions and associated force feedback features 32.

In this way, the second body 52 and selector 12 may be rotated from the fourth position, through the third and second positions and to the first position. As the selector 12 reaches the first position, the cam surface 128 may be generally aligned with the path of motion of the drive surface 96 such that further rotation of the second body 52 does not occur. This permits the first tab 84 to be moved into the first void 90 without rotation of the second body 52 which would move the first void 90 out of alignment with the first tab 84. In this way, the retainer 64 can be moved back to its first position, and then the shifter 10 is returned to the park position shown in FIGS. 7 and 8.

Of course, it may also be possible to move the shifter 10 to a different position other than the first position, such as the third position in which the transmission is in neutral. Instead, the shifter 10 could be driven/rotated in the opposite direction, e.g. from a lower numbered position to a higher numbered position by suitably arranged driving and cam surfaces (which may involve driving the retainer away from the actuator toward an extended position).

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A shifter for a vehicle transmission, comprising:
a first shift member having a body rotatable about an axis among multiple positions;
a retainer movable relative to the body, the retainer being movable between a first position in which the retainer prevents movement of the body and a second position in which the retainer permits movement of the body;
an actuator coupled to the retainer to drive the retainer between the first position and second position; and
a second shift member coupled to the first shift member and driven by the actuator between first and second positions to rotate the body.

2. The shifter of claim 1 wherein the second shift member is engaged by the retainer and driven by movement of the retainer.

3. The shifter of claim 1 wherein the retainer and body include control features that are radially overlapped relative to the axis when the retainer is in the first position are not radially overlapped when the retainer is in the second position.

4. The shifter of claim 3 wherein the control features include axially extending stop surfaces of the retainer and the body.

5. The shifter of claim 1 wherein the retainer includes one or more control features with one of the one or more retainer control features selectively and releasably engageable with a first control feature of the body when the body is in a first position, and the body may also include a second control feature that is selectively and releasably engageable by one of the one or more retainer control features when the body is in a second position that is different than the first position of the body.

6. The shifter of claim 1 wherein the second shift member has a first end, a second end and is coupled to a pivot between the first end and second end for rotation of the second shift member about the pivot, and wherein the second shift member is coupled to the body between the pivot and first end and the retainer is engageable with the second shift member between the pivot and second end, and wherein rotation of the body causes the second shift member to rotate about the pivot and engagement of the retainer with the second shift member during movement of the retainer causes the second shift member to rotate about the pivot and rotate the body.

7. The shifter of claim 6 wherein the distance from the pivot to the first end is greater than the distance from the pivot to the second end.

8. The shifter of claim 6 wherein the body rotates about an axis that is parallel to an axis of the pivot.

9. The shifter of claim 8 wherein the second shift member rotates about the axis of the pivot and in at least one position of the body, the second shift member intersects an imaginary line that intersects the axis about which the body rotates and the axis of the pivot.

10. The shifter of claim 1 wherein the second shift member includes a slot and the body includes a drive member received within the slot, and during rotation of the body, the drive member moves relative to the second shift member within the slot.

11. The shifter of claim 10 wherein the drive member is closely received within the slot to prevent lost motion between the body and the second shift member.

12. The shifter of claim 1 wherein the retainer includes a cam surface at least a portion of which is located between the pivot and second end, wherein the cam surface is inclined relative to a path of movement of the retainer so that engagement of the retainer with the cam surface of the second shift member causes increased rotation of the body.

13. A shifter for a vehicle transmission, comprising:
a first shift member having a body rotatable about an axis between a park position, a reverse position, a neutral position and a drive position, and the first shift member has at least one shifter control feature;
a retainer movable along a linear path relative to the body and having at least one retainer control feature, the retainer being movable between a first position in which the retainer control feature overlaps the shifter control feature when the shifter is in the park position to prevent rotation of the body, and a second position in which the retainer control feature does not overlap the shifter control feature and rotation of the body is permitted;
an actuator coupled to the retainer to drive the retainer between the first position and second position; and
a second shift member coupled to the first shift member so that the second shift member is in a first position when the first shift member is in the park position and the second shift member is in a position different than the first position when the first shift member is not in the park position, and the second shift member has a portion engageable by the retainer as the retainer moves from the second position to the first position so that when the retainer is in the first position the second shift member is in the first position and the first shift member is in the park position.

14. The shifter of claim 13 wherein when retainer is not in the first position and the shift member is in a position other than the park position, the actuator may drive the retainer to the first position to cause the retainer to engage and drive the second shift member and cause the second shift member to rotate the first shift member to the park position.

15. The shifter of claim 13 wherein the second shift member has a first end, a second end and is coupled to a pivot between the first end and second end for rotation of the second shift member about the pivot, and wherein the second shift member is coupled to the body between the pivot and first end and the retainer is engageable with the second shift member between the pivot and second end, and wherein rotation of the body causes the second shift member to rotate about the pivot and engagement of the retainer with the second shift member during movement of the retainer causes the second shift member to rotate about the pivot and rotate the body.

16. The shifter of claim 15 wherein the distance from the pivot to the first end is greater than the distance from the pivot to the second end.

17. The shifter of claim 15 wherein body rotates about an axis that is parallel to an axis of the pivot.

18. The shifter of claim 15 wherein the retainer includes a drive surface and the second shift member includes a cam surface engageable by the retainer, the cam surface is not parallel to the path of movement of the retainer when the second shift member is not in the first position so that engagement of the retainer with the cam surface rotates the second shift member about the pivot.

19. The shifter of claim 13 wherein the retainer is closer to the actuator when the retainer is in the first position than when the retainer is in the second position.

20. The shifter of claim 13 wherein the actuator is an electric motor and includes a rotary spindle, and wherein the retainer is coupled to the rotary spindle for linear movement in one direction when the spindle is driven by the motor in a first direction and for linear movement in a second direction when the spindle is driven by the motor in a second direction.
